(19) United States
(12) Patent Application Publication
(10) Pub. No.: US 2008/0047143 A1
(43) Pub. Date: Feb. 28, 2008

(54) Endodontic Instrument

(75) Inventors: Nancy N. Quan, North Hills, CA (US); Ben Wu, San Marino, CA (US)

Correspondence Address: DISCUS DENTAL IMPRESSIONS, INC., 8550 HIGUERA STREET, CULVER CITY, CA, 90232, US

(73) Assignee: Discus Dental, LLC., Culver City, CA (US)

(21) Appl. No.: 11/929,437

(22) Filed: Oct. 30, 2007

Related U.S. Application Data
(62) Division of application No. 11/591,891, filed on Nov. 1, 2006.
(60) Provisional application No. 60/732,367, filed on Nov. 1, 2005.
(60) Provisional application No. 60/732,047, filed on Nov. 1, 2005.
(60) Provisional application No. 60/732,361, filed on Nov. 1, 2005.
(60) Provisional application No. 60/732,039, filed on Nov. 1, 2005.

(51) Int. Cl. B23P 15/00

(52) U.S. Cl. 29/896.1

(57) ABSTRACT

A method of manufacturing endodontic instruments is disclosed. Each of the instruments includes a substantially non-cutting pilot portion, a relatively short working portion, and a flexible shank portion which is of a substantially smaller average circumferential span than the working portion. The working portion of one instrument may have a maximum circumferential span as that of the blank from which it is made. The instrument may be treated with either a surface treatment and/or a bulk treatment. The instrument may have a handle at its distal end for manual manipulation, or may be adapted for attachment to a mechanical handpiece. The non-cutting pilot, the short length of the working portion, and the flexibility of the shank combine to allow the instrument to be used in curved root canals without causing undue change in the natural root canal contours.

### CROSS-REFERENCE TO RELATED APPLICATIONS

This application claims the benefit of U.S. Provisional Patent Application 60/732,367 entitled “Endodontic Instrument” filed Nov. 1, 2005; U.S. Provisional Patent No. 60/732,047 entitled “Endodontic Instrument” filed Nov. 1, 2005; U.S. Provisional Patent Application No. 60/732,631 entitled “Endodontic Instrument” filed Nov. 1, 2005; and U.S. Provisional Patent Application No. 60/732,039 entitled “Treated Endodontic Instrument” filed Nov. 1, 2005 the entire contents of which are incorporated by reference.

### FIELD OF THE INVENTION

This invention relates to endodontic instruments for use in root canal dental procedures in general. More specifically, this invention relates to a method for manufacturing endodontic instruments.

### BACKGROUND OF THE INVENTION

Both circulatory and neural support for a tooth enters the tooth at the terminus of each root. During a root canal operation, any diseased pulp tissue in the root canal is extracted using endodontic files and reamers that are generally tapered. These instruments generally have working portions along the major portions of the file. Since the root canals are small, curved and calcified, the instruments used have to withstand high torsional stresses during such removal process so as not to complicate the treatment by breaking.

The endodontic files and reamers used to clean out and shape the root canal are rotated and reciprocated in the canal by dentists, either manually or with the aid of dental handpieces onto which the files are mounted. Files of increasingly larger diameters are generally used in sequence in order to achieve the desired cleaning and shaping.

Many endodontic instruments used for this operation have torsional limitations. Some of the improved ones are disclosed in U.S. Pat. Nos. 4,538,989, 5,464,362, 5,527,205, 5,628,674, 5,655,950, 5,762,497, 5,762,541, 5,833,457, 5,941,760, and 6,293,795, the contents of these are incorporated herein by reference. Some of these patents teach endodontic files made with an alloy of nickel/titanium containing more than 40% titanium.

The files and reamers also have varying designs of cutting edges and some of these designs are disclosed in U.S. Pat. Nos. 4,299,571, 4,332,561, 4,353,698, 4,457,710, 4,661,061, 4,850,867, 4,904,185, 5,035,617, 5,067,900, 5,083,923, 5,104,316, 5,275,562, 5,735,689, 5,902,106, 5,938,440, 5,980,250, 6,293,794, and 6,419,488, 6,428,317, and Patent Application Publication Nos. US2002/0137008 A1, and US2004/0023186 A1, incorporated herein by reference. Most of these files have working portions spanning the lengths of the shanks and include helical cutting surfaces.

### SUMMARY OF THE INVENTION

The present invention relates to a method of manufacturing an endodontic instrument. The instrument includes a pilot portion at its proximal end, a relatively short working portion, and a flexible shank portion towards its distal end, a portion of which is of a substantially smaller average circumferential span than the working portion. The working portion may be towards the proximal end or towards the mid-portion of the instrument.

According to one embodiment of the invention, the method for manufacturing includes:

providing a blank for making an instrument, said blank having a circumferential span,;

grinding said blank to form a non-working shank portion having a proximal end and a distal end, at least a portion of the shank having a substantially smaller circumferential span than that of the blank;

forming a working portion extending not more than the length of the non-working shank on said blank adjacent the distal end of the non-working shank, and having a maximum circumferential span substantially corresponding to the circumferential span of the blank;
forming a pilot portion near one end of the blank close to the working portion; and

treating at least a portion of the instrument including at least a portion of the shank portion, the working portion, the pilot portion or combinations thereof.

In one embodiment, at least a portion towards the proximal end of the non-working shank has substantially the same circumferential span as that of the blank. In another embodiment, the entire length of the shank may have a substantially smaller circumferential span than that of the blank. In a further embodiment, the shank may be tapered towards the proximal portion. In yet another embodiment, the shank may have a portion having a reduced circumferential span towards the proximal end to create a weak point.

The blank may also be treated prior to the grinding process. In one embodiment, the blank may be treated at the manufacturing stage of the blank. In another embodiment, the blank may be treated after the blank manufacturing process, but before the grinding process.

In one aspect, the treatment methods may include coating, sandblasting, anodizing, ion implantation, electro-polishing, etching or combinations thereof, for modifying at least a portion of the working portion, and/or the shank portion, and/or the pilot portion.

In another aspect, a blank may be subjected to heat setting, a cryogenic treatment, or combinations thereof.

In a further aspect, the instrument or blank may have a coating for improving durability, and/or lubricity and/or improving cutting efficiency and/or strength.

Some treatment methods may also impart a different color to the treated portions. These colored portions may serve as length, depth or wear indicators.

The colored portion or section may remain on the un-ground portion. For the working portion, the un-ground portion may serve as a depth or length indicator, or a wear indicator.

In one embodiment, the pilot portion may be a non-cutting portion. In another embodiment, the pilot portion may include abrasive surfaces. In yet another embodiment, the pilot portion may be a continuous extension of the working portion.

The present invention also relates to an endodontic instrument including:

a relatively short working portion having a maximum circumferential span substantially corresponding to the circumferential span of a blank used to make the instrument;

a pilot portion adjacent one end of the working portion; and

a flexible shank portion adjacent the other end of the working portion, a portion of which is of a substantially smaller average circumferential span than the working portion; wherein at least a portion of the instrument including at least a portion of the shank portion, the working portion, the pilot portion or combinations thereof has been treated.

In one aspect, the blank is a treated blank. In another aspect, the outer surfaces of portions of the instrument have been treated. In a further aspect, the instrument and /or blank may be coated.

The present invention further relates to a method of manufacturing a set of endodontic instruments having varying circumferential spans.

According to one embodiment of the invention, the method includes:

providing a set of blanks for making instruments, each having a circumferential span;

grinding each blank to generate a non-working shank having a proximal end and a distal end, at least a portion having a substantially smaller circumferential span than that of the blank;

forming a working portion adjacent to and extending not more than the length of the non-working shank and having a maximum circumferential span substantially corresponding to the circumferential span of the respective blank;

forming a pilot portion near one end close to the working portion of each instrument; and

treating at least a portion of each of the instruments, said portion including at least a portion of the shank, the working portion, the pilot portion or combinations thereof.

In one aspect, at least a portion towards the proximal end has substantially the same circumferential span as that of the blank. In another aspect, the entire length of the shank may have a substantially smaller circumferential span than that of the blank. In a further embodiment, the shank may be tapered towards the proximal portion. In yet another embodiment, the shank may have a portion having a reduced circumferential span towards the proximal end to create a weak point.

According to another embodiment of the invention, the method includes:

providing a set of blanks for making instruments, each having an identical circumferential span;

grinding each blank to generate a non-working shank having a proximal end and a distal end, at least a portion having a substantially smaller circumferential span than that of the blank;

forming a working portion adjacent to and extending not more than the length of the non-working shank, one instrument in the set having a maximum circumferential span substantially corresponding to the circumferential span of the blank;

forming a pilot portion near one end close to the working portion of each instrument.

In one embodiment, the shank portion of each of the instruments in the set is of substantially the same circumferential span which is smaller than that of the blank. In another embodiment, only one instrument in the set has at least a portion of the shank portion that is of the substantially the same circumferential span as that of the blank, and all the other ones have smaller circumferential span than the blank. In a further embodiment, all instruments have at least a portion of the shank portion that is of substantially the same circumferential span as that of the blank.

In one embodiment, at least a portion of each of the instruments, including at least a portion of the shank, the working portion, the pilot portion or combinations thereof, may be treated. In one aspect, the treatment methods may include coating, sandblasting, anodizing, ion implantation, electro-polishing, etching or combinations thereof, for modifying the working portion, and/or the shank, and/or the pilot portion. In another aspect, a blank or instrument may be subjected to heat setting, cryogenic treatment, or combinations thereof.

As mentioned above, when a coated or treated blank is used, the treated surfaces or coating may be of a different color from the blank itself. The colored portion or section may remain on the un-ground portion. For the working portion, the un-ground portion may serve as a depth or length indicator, or a wear indicator.

The blanks may also be treated prior to the grinding process, as noted.

According to a further embodiment of the invention, the method for manufacturing a set of endodontic instruments includes:

providing a set of groups of blanks for making a set of groups of instruments, each group of blanks includes a circumferential span, and each group of blanks having a different circumferential span from any other group of blanks;

grinding each blank to generate a non-working shank having a proximal end and a distal end, and each instrument made from the same group of blanks has at least a portion of the shank having a substantially smaller circumferential span than that of the blank;

forming a working portion having a circumferential span, said working portion adjacent to and extending not more than the length of the non-working shank;

forming a pilot portion near one end of each blank close to the working portion; wherein only the working portion of one instrument made from each group of blanks having a maximum circumferential span substantially corresponding to the circumferential span of each group of blanks.

In one embodiment, at least one of said instruments made from the same group of blanks has at least a portion towards the proximal end of the shank having substantially the same circumferential span as that of the blank. In another embodiment, the entire length of the shank portion of all instruments made from the same group of blanks may have a substantially smaller circumferential span than that of the blank.

The method may include a treating process, as noted above. In one aspect, at least a portion of each of the instruments including the shank portion, the working portion, the pilot portion or combinations thereof may be treated. In one embodiment, the treatment methods may include coating, sandblasting, anodizing, ion implantation, electro-polishing, etching or combinations thereof, for modifying the working portion. In another embodiment, a blank may be subjected to heat setting, cryogenic treatment, or combinations thereof. For the coated or treated blank, as mentioned above, the treated surfaces or coating may be of a different color from the blank itself. The colored portion or section may remain on the un-ground portion. For the working portion, the un-ground portion may serve as a depth or length indicator, or a wear indicator.

In another aspect, the blanks may be treated prior to the grinding process, as also noted above.

In one embodiment, a series of two instruments may be made from one group of blanks having identical circumferential span even though only one of the instruments has a working portion having the same circumferential span as the blank. In another embodiment, a series of three instruments may be made from a group of blanks having identical circumferential span even though only one of the instruments has a working portion having the same circumferential span as the blank. In other embodiments, more than three instruments may be made from a group of blanks having identical circumferential span even though only one of the instruments has a working portion having the same circumferential span as the blank.

In one embodiment, the number of group is equal to one.

The present invention still further relates to a set of groups of endodontic instruments made from a set of groups of blanks, each group including an instrument having:

a relatively short working portion having at least one working surface having a maximum circumferential span;

a pilot portion; and

a flexible shank portion adjacent the working portion, a portion of which is of a substantially smaller average circumferential span than the working portion; wherein only one instrument in each group has a maximum circumferential span substantially corresponding to the circumferential span of each group of blanks.

In one aspect, at least a portion of each of the instruments including the shank, the working portion, the pilot portion or combinations thereof may be treated.

In another aspect, at least one instrument made from each group of blanks has a portion towards the proximal end of the shank portion having substantially the same circumferential span as that of the blank.

In a further aspect, the short working portion extends not more than the length of the non-working shank portion.

In one embodiment, the instrument may have a handle at its distal end for manual manipulation. In another embodiment, instrument may have a handle at its distal end that is adapted for attachment to a mechanical handpiece, including a rotary handpiece. At least a portion of the end attaching to the handle portion is treated. The treatment may improve the attachment strength and minimize separation of the shank portion from the handle portion.

The substantially non-cutting pilot, the short length of the working portion, and the flexibility of the shank portion combine to allow the instrument to be used in curved root canals without causing undue change in the natural root canal contours.

The blank may have a substantially circular, a substantially rectangular, a substantially triangular, or a substantially elliptical cross-section.

The working surfaces may be helical; may have edges forming a continuous curve; may have edges twisting not more than 359° about the longitudinal axis; may have curved cutting edges about the longitudinal axis; may have straight cutting edges along the longitudinal axis; may have straight cutting edges at an oblique angle from the longitudinal axis; may have cutting edges having projections that are non-intersecting with each other or the longitudinal axis; or combinations thereof.

In one embodiment, the pilot portion may be about the same length as the working portion. In another embodiment the pilot portion may be an extension at the end of the working portion.

While the working portion and the pilot portion may be formed by grinding, as described above, they may also be formed by casting or molding.

The present invention together with the above and other advantages may best be understood from the following detailed description of the embodiments of the invention illustrated in the drawings below.

### BRIEF DESCRIPTION OF THE DRAWINGS

FIG. 1 shows a prior art endodontic instrument;

FIGS. 2 and 2a each shows an embodiment of an endodontic instrument made with methods according to the present invention;

FIGS. 3, 3a and 3b each shows another embodiment of an endodontic instrument made with methods according to the present invention;

FIGS. 4, 4a1, 4a, 4b, 4c, 4c1, 4d, 4e, 4e1, and 4f each shows a further embodiment of an endodontic instrument made with methods according to the present invention;

FIG. 5 shows a schematic block diagram depicting an exemplary method according to the present invention for making an endodontic instrument

FIG. 6 shows an exemplary equipment used in the manufacturing process of the present invention;

FIG. 7 shows an exemplary endodontic instrument of the present invention having a handle;

FIGS. 7a and 7b show an exemplary endodontic instruments of the present invention having rotary handles;

FIGS. 8a, 8b and 8c each illustrates a series of endodontic instruments of the present invention having different maximum circumferential spans or diameters of the working portion; and

FIGS. 9 and 9a each shows another embodiment of an endodontic instrument of the present invention.

### DETAILED DESCRIPTION OF THE INVENTION

The detailed description set forth below in connection with the appended drawings is intended as a description of the presently exemplified embodiments of dental instruments or tools in accordance with the present invention, and is not intended to represent the only forms in which the present invention may be constructed or utilized. The description sets forth the features and the process for constructing and using the dental tools or instruments of the present invention in connection with the illustrated embodiments. It is to be understood, however, that the same or equivalent functions and structures may be accomplished by different embodiments that are also intended to be encompassed within the spirit and scope of the invention.

An endodontic instrument in accordance with the present invention may be used in a root canal procedure. Some exemplary configurations may be found in U.S. Pat. No. 4,850,867, the content of which is incorporated herein by reference.

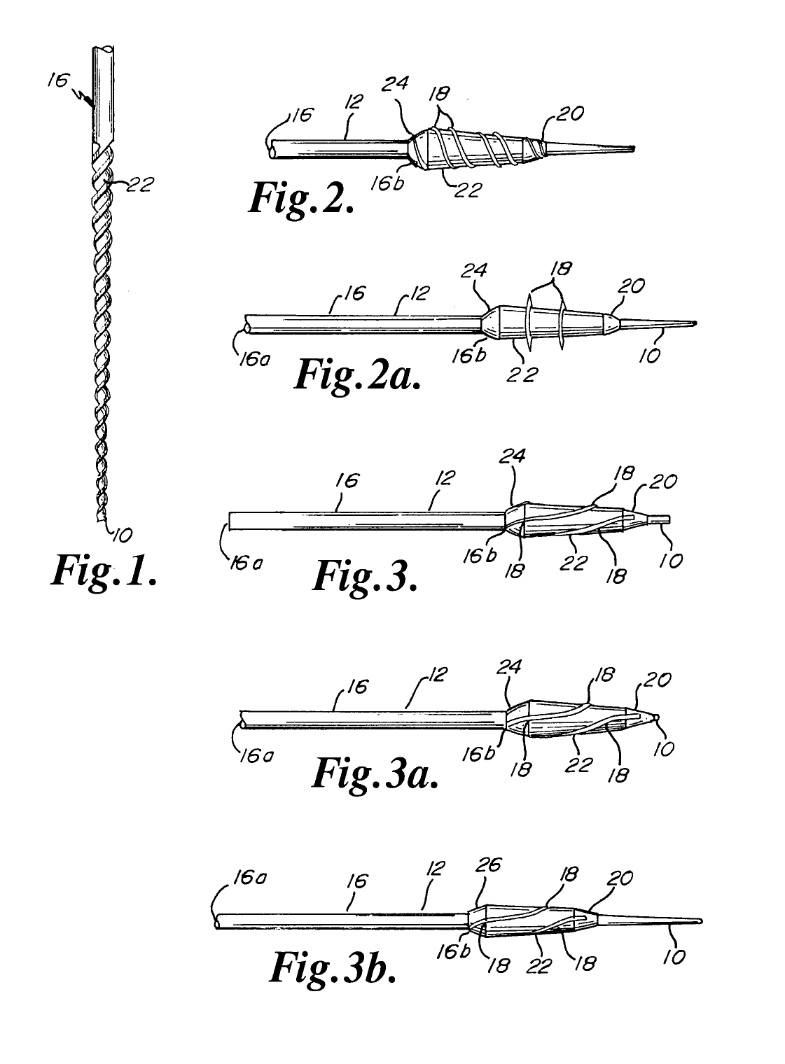

Traditional instruments typically include long, tapered working portions 22 having helical flutes along the entire length of the working portion 22, such as shown in FIG. 1. These instruments are typically made by grinding a cylindrical wire. Such long working portions also mean more contact area between the root canal and the instrument, thus subjecting the instrument to higher torsional forces during operation.

An endodontic instrument 12 of the present invention has a relatively short working portion 22, as exemplified in FIGS. 2, 2a, 3, 3a, 3b, 4, 4a1, 4b, 4c, 4c1, 4d, 4e, 4e1, or 4f, leading to smaller areas of contact with the root canal. The smaller contact areas may result in lower torsional forces on the instrument 12 during use. The shorter working portion 22 also may provide the dentist with substantially improved control over where cutting of dentin occurs and therefore causes much less unintended cutting of dentin and change of the natural curvature.

In the present invention, a blank 30 of a substantially circular, a substantially square, a substantially rectangular, a substantially triangular, or a substantially elliptical cross-section may be ground to form an endodontic instrument 12, as exemplified in FIGS. 2, 2a, 3, 3a and 3b.

The present invention includes an instrument 12 having a shank portion 16 that has a substantially smaller circumferential span or diameter for the major portion of its length than a traditional instrument. A small circumferential span or diameter leads to a more flexible instrument. This flexibility allows the instrument 12 to follow the curve of a canal more easily.

The shank portion 16 is also longer than the working portion 22. A traditional instrument, by contrast, has a very short shank portion 16, if any. The length of the shank portion 16 provides for an instrument 12 that may bend more readily as it encounters any change in direction in the channel of the tooth.

The instrument 12 also has a substantially non-cutting pilot portion 10. The pilot portion 10, the short length of the working portion 22, in addition to the length and flexibility of the shank 16, all combine to further allow the instrument 12 of the present invention to more easily follow the natural curvature of the entire root canal without causing undue change in the natural root canal contours. It also opens up more choices for materials that may be suitable for constructing the instrument 12, including materials that may not be suitable for traditional instruments, materials that are not traditionally considered as having high degrees of flexibility, or materials having improved strength. Such improvements may be introduced through treatments such as cryogenic treatments, heat setting or combinations thereof.

Such treatments for improved strength, which may introduced a correspondingly undesirable loss in flexibility of the blank sometimes, may still generate blanks that are suitable for the present invention because of the configuration of the instrument of the present invention.

The blank 30 may include a titanium alloy such as nickel-titanium alloy, titanium-nitride alloy, titanium-aluminum-vanadium alloys or similar; stainless steel; silver and silver alloys; aluminum; any amorphous metals; or a similar metal that is amenable to being drawn into a blank 30 of small diameter or circumferential span or a wire-like form. For a titanium alloy, the amount of titanium may be present at, for example, at least about 25% by weight, more for example, may be present at, for example, at least about 50% by weight. The nickel-titanium alloys may also include impurities such as C, O, N, Co, Cr, Zr, Hf, Nb, Pt, Pd, V, Fe or mixtures thereof. Fe may also strengthen and improve ductility of the alloy. These blanks 30 may be made into endodontic instruments 12 having good torsional resistance and good flexibility.

A suitable non-metal may also be used and may include a polymeric alloy such as ULTEM®, which is an amorphous thermoplastic polyetherimide, Xenoy® resin, which is a composite of polycarbonate and polybutyleneterephthalate, Lexan® plastic, which is a copolymer of polycarbonate and isophthalate terephthalate resorcinol resin (all available from GE Plastics); liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198, the contents of which are incorporated herein by reference), polyesterimide anhydrides with terminal anhydride group or lateral anhydrides (exemplified in U.S. Pat. No. 6,730,377, the content of which is incorporated herein by reference); any or combinations thereof.

The blank 30 may be present in a continuous spool. When the blank 30 is in a spool, it may undergo a straightening process prior to being cut and/or ground. For a blank 30 of nickel-titanium alloy, the straightening process is not needed as the winding process does not impart a permanent memory to the blank 30.

In one embodiment, the blank 30 may be cut into the needed dimension prior to feeding the blank 30 through the grinding process. In another embodiment, the blank 30 may be fed through the grinding process prior to being cut into the required dimension.

An instrument 12 typically has a length of about 30 mm (1.2 inches), and has a proximal end adapted to be mounted to a conventional handle 25, as shown in FIG. 7 or to rotary handles 25, as shown in FIGS. 7a and 7b. The conventional handle 25 may be adapted for manual cutting of the root canal. The rotary handles 25 may be adapted for mounting to a mechanical handpiece, such as a rotary handpiece or vibratory handpiece. The shank portion 16 may be cylindrical, as shown in FIGS. 2 and 3, or may be of any other cross-section mentioned above, and may have a circumferential span or diameter of between about 0.2 to about 0.8 mm (0.01 and 0.03 inches). The working portion 22 may have a length of about 0.5 mm (0.02 inches, or up to about 14 mm (0.5 inches). In one embodiment, the working portion 22 may be cylindrical. In another embodiment, the working portion 22 may be ground to be slightly tapered towards the pilot portion 10. In a further embodiment, the working portion 22 may be ground to be slightly tapered towards the shank portion 16. In yet another embodiment, the working portion 22 may be ground to be slightly tapered towards both the pilot end 10 and the shank portion 16, as shown, for example, in FIGS. 2, 2a, 3, 3a, 3b, 4, 4a, 4b, 4c, 4d, 4e, 8a, 8b and 8c. Any or all of these illustrates embodiments of an endodontic instrument 12 which may be fabricated in accordance with the present invention.

The working portion 22 of the instrument 12 may be flat, or substantially in one plane, and having a thickness as shown in FIGS. 3, 3a, 4 and 5. In one embodiment, the flattened working portion 22 may vary in thickness, from the thinner edge to a thicker central portion. In another embodiment, the thickness of the working portion 22 may be substantially uniform. In another embodiment, the working portion 22 may have projections that are out of plane or may be of a wedge-like section or projections 18 that are not helically wound with respect to the longitudinal axis of the shank 16, as exemplified in FIGS. 2a, 2d 3, 3a, and 4. The projecting sections 18 extend beyond radius R of the shank 16, as measured perpendicular to the longitudinal axis. One or more of these projections 18 may be straight, radiating outward about the working portion 22 in one plane, as shown in FIG. 2a.

Referring to FIGS. 2 and 2a, the working portion 22 may have a substantially circular cross-section. As shown, the working portion 22 may also have a slight taper present at both ends of the working portion 20 and 24, as shown. The tapering makes the largest diameter portion not towards either one of the ends 20 and 24, but either about the mid-section of the working portion 22, or just off the mid-section of the working portion 22, as shown in FIGS. 2, 2a, 3, 3a, 3b, 4, 4a, 4b, 4c, 4e and 4f.

The working portion 22 may also be suitably tapered in three portions. A first transition portion 20 increases in diameter from the distal end of the pilot portion 10 until it meets the main body of the working portion 22. The main body portion also increases in diameter towards its distal end 24, but may be at a lesser angle than the first transition portion 20, or vice versa. The main body of the working portion 22 connects at its distal end to a second transition portion 24 which decreases in diameter from its proximal end to its distal end, where the second transition portion 24 connects to the shank portion 16. Other embodiments are possible, including a reverse taper whereby the proximal end diameter of the working portion 22 may be greater than the distal end diameter, or any other combination.

In the embodiments as exemplified in FIGS. 2, 2a, 3, 3a, 3b, 4, 4a, 4b, 4c, 4e and 4f, the non-working shank 16 is of a substantially cylindrical shape and has a proximal end 16a and a distal end 16b. In other embodiments, shanks 16 having other cross-sectional shapes, such as a triangle, a square or a rectangle, may also be contemplated.

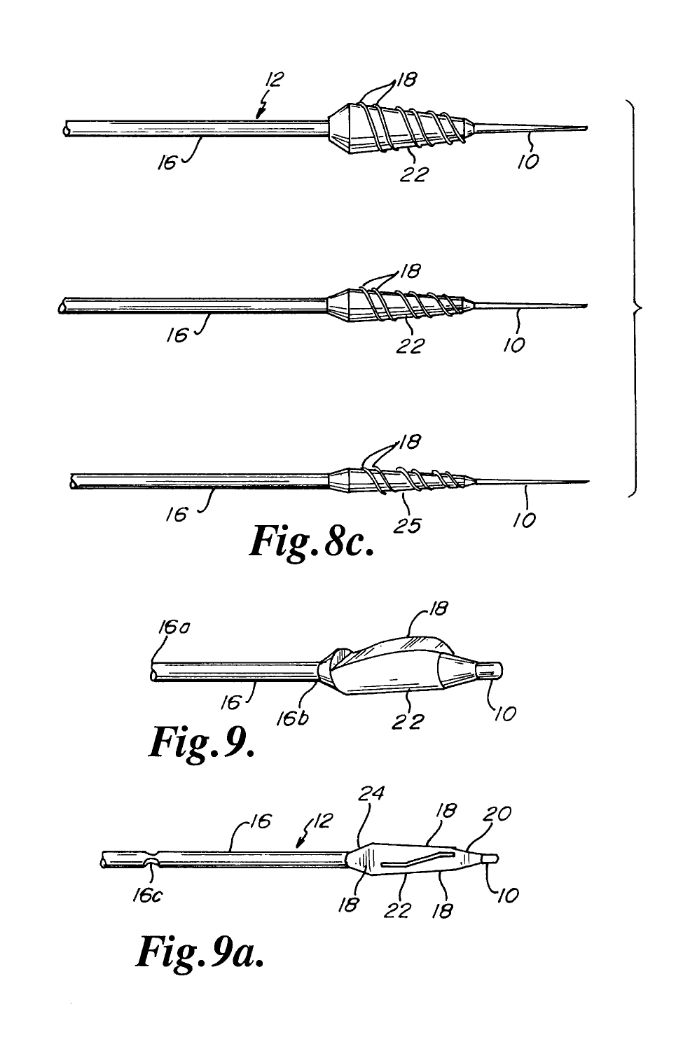

The tapered end 24 of the working portion 22 is contiguous with the distal end 16b of the non-working shank 16. In one embodiment, the tapered end 24 may be tapered such that at the point of joining with the distal end 16b of the non-working shank 16, there is a matching of diameters. In another embodiment, the distal end 16b is of a slightly larger diameter than the narrow portion of the non-working shank 16 so that there is a smooth transition from the tapered end 24 of the working portion 22 towards the non-working shank 16. This is shown in FIG. 9, and will be discussed further below. In a further embodiment, the proximal end of the non-working shank 16 may have a slightly larger diameter than the rest of the non-working shank 16.

In the embodiments as shown in FIGS. 2 and 2a, the outer peripheral of the working portion 22 includes at least two spiral or helical working surfaces 18 (as shown in FIG. 2), or the surfaces 18 may form at least two continuous curves (as are shown in FIG. 2a). In other embodiments, the working portion 22 may have one helical working surface 18, or one continuous curve.

In some embodiments, the working portion 22 may be flattened and/or otherwise shaped to alter its cross-sectional geometry. In one embodiment, the working portion 22 may be flatted to an extent that the cross-section is an ellipse. In another embodiment, the working portion 22 may be flattened substantially so the cross-section resembles a flattened quadrilateral.

The at least two spiral or helical working surfaces 18 may be formed prior to flattening the working portion 22, which may result in a substantially spiral or helical structure(s) 18 that may include significant working surfaces that may contact the work space on the apical portions of the longest dimension of the cross section of working portion 22.

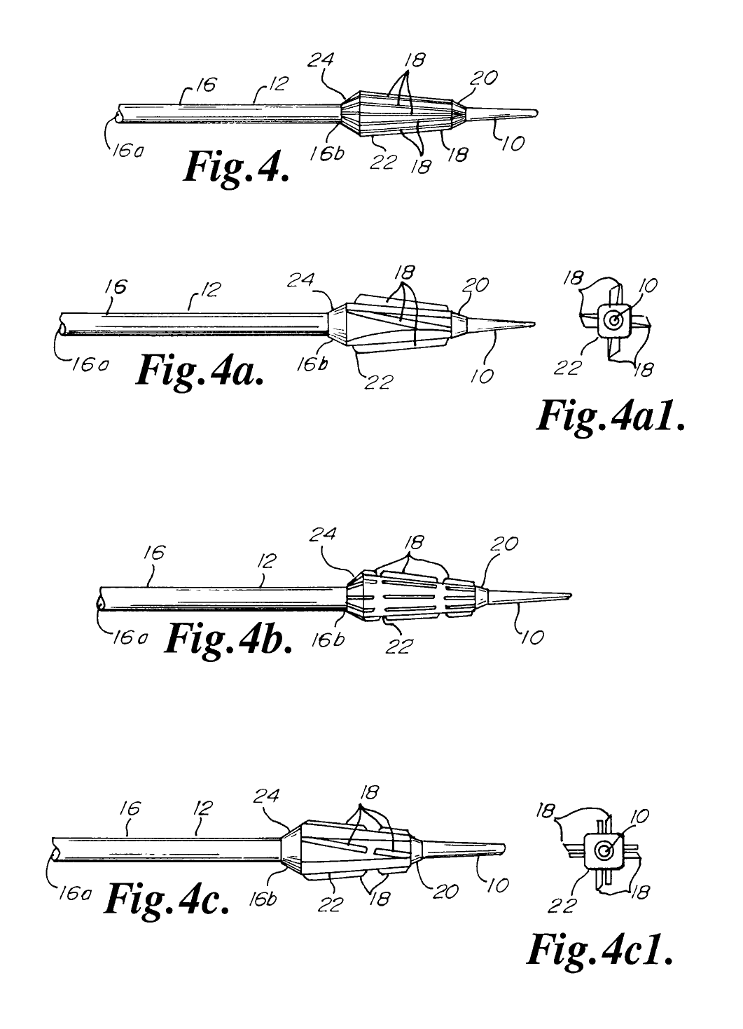

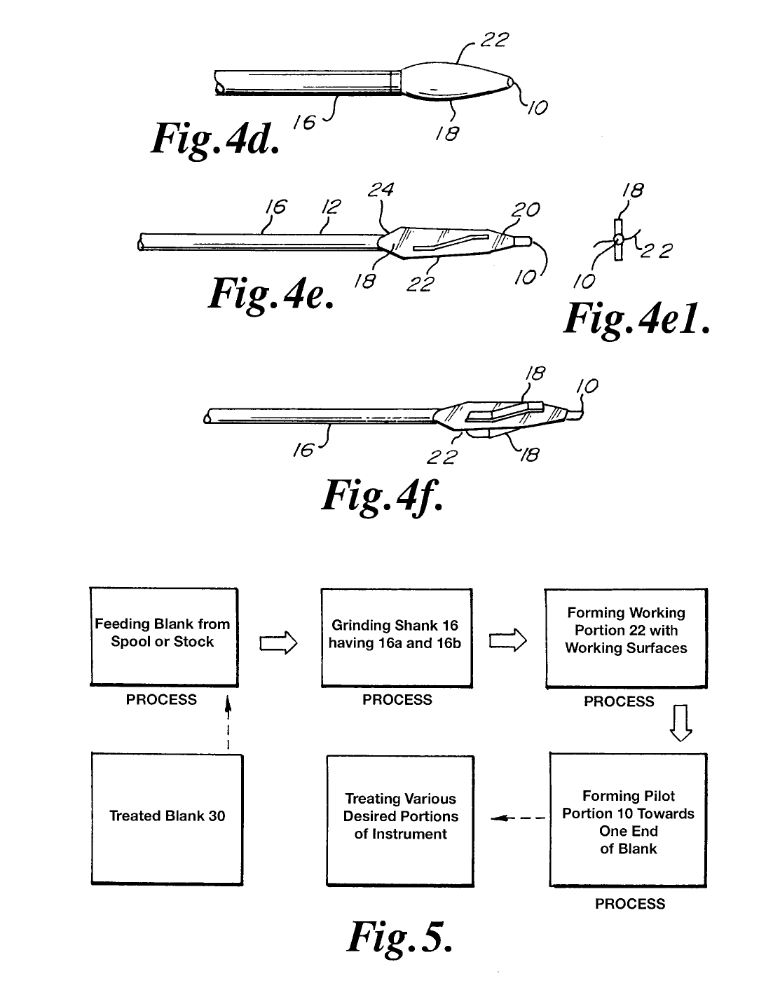

Other embodiments of the working portion having other configurations of the working surfaces 18 are described in FIGS. 3, 3a, 3b, 4, 4a, 4b, 4c, 4d, 4e, and 4f.

FIGS. 3, 3a and 3b show an instrument having curved working or cutting surfaces or edges 18 along the outer peripheral of the working portion 22. These curved edges 18 may twist or curve not more than 359° about the longitudinal axis of the shank portion 16, such as exemplified in FIG. 4.

In another embodiment, the working surfaces or edges 18 may be straight, either along the longitudinal axis of the working portion 16, or at an oblique angle, as shown in FIGS. 4 and 4a. The straight cutting edges or surfaces 18 may extend substantially along the length of the working portion in one continuous edge, as are also shown in FIGS. 4 and 4a. In other embodiments, each of the straight cutting edges may be in several sections, as shown in FIGS. 4b and 4c. FIGS. 4a1 and 4c1 clearly show the working or cutting surfaces 18 of the embodiments 4a and 4c, when viewed straight on from the pilot portion 10.

In the embodiments as shown in FIGS. 4, 4a, 4b and 4c, the cross-section of the working portion may be of a substantially rectangular shape. If the cross-section is substantially circular, the longitudinally straight or oblique edges may follow the curved portions of the working portion, but still in substantially straight or oblique fashion.

The working portion 22 may also be flattened, rather than cylindrical. One exemplary embodiment is shown in FIG. 4d. In a flattened working portion 22, the two outer edges 18 and the front edges would normally do the cutting. The cross section of such a working portion 22 would be a relatively thin rectangle.

In another embodiment, the flattened working portion 22 may include at least one projecting section 18, each projecting section extending towards the pilot portion 10, the projecting section 18 including a leading portion extending forward of the portion having a maximum circumferential span and making an angle with the longitudinal axis of the shank 16 of less than about 90° and a trailing edge portion extending rearward of the portion having a maximum circumferential span and making an angle of less than about 90° with the same longitudinal axis, each projecting section does not twist about the longitudinal axis of the working portion more than 359° about the longitudinal axis, as exemplified in FIG. 4e, or the cross-sectional view in FIG. 4e1; or the projections 18 that are non-intersecting with each other or the longitudinal axis, as exemplified in FIG. 4f.

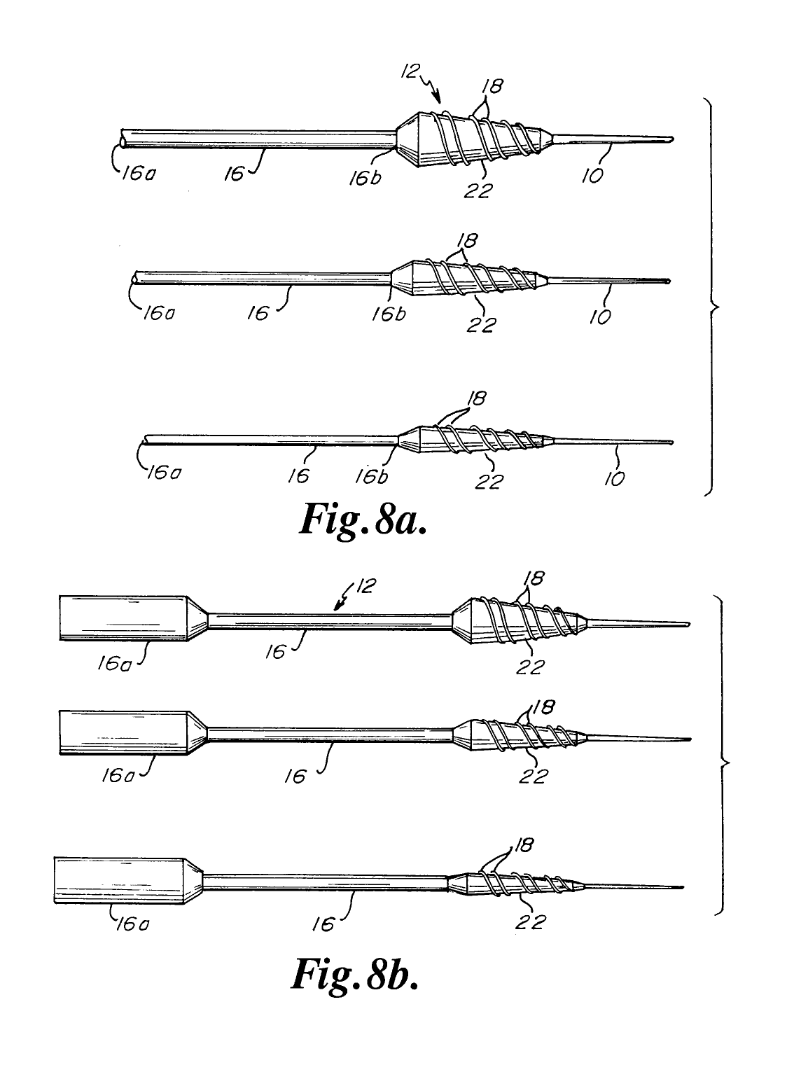

Of the two portions of the non-working shank 16, the portion towards the proximal end 16a may be of a larger or smaller circumferential span, for example, diameter, than the portion towards the distal end 16b. In one embodiment, the proximal portion 16a and distal portion 16b may be ground so that the proximal portion 16a may be of a smaller, for example, diameter than the largest diameter portion of the working portion 22, such as shown in FIG. 9. In another embodiment, only the distal portion 16b may be ground so that the proximal portion is of approximately the same diameter as the largest diameter working portion 22, such as exemplified in FIG. 8b. In a further embodiment, the shank 16 may be ground in such a way that the distal end 16b transitions smoothly form the distal end 24 of the working portion 22 and tapers towards the proximal end 16a, as shown in FIG. 9. In yet a further embodiment, the shank 16 may be ground to have a portion 16c having a reduced circumferential span or diameter, as shown in FIG. 9a. The non-working shank 16 may generally be solid.

The tip of an instrument 12 in accordance with the present invention may be formed with a substantially non-cutting pilot portion 10, while most standard instruments have a cutting tip. The configuration of the shank 16 of the present invention may also be ground to provide more flexible shanks 16 than in comparable standard instruments 12, as noted before. In general, the shank portion 16 may also be substantially longer than the working portion 22, providing for a working portion 22 that may bend as it encounters any change in direction in the channel of the tooth, to more easily follow the curve of a canal. The substantially non-cutting pilot portion 10, the short length of the working portion 22, and the flexibility of the shank 16, all combine to allow the instrument of the present invention to more easily follow the natural curvature of the entire root canal without causing undue change in the natural root canal contours. The shorter cutting lengths also may provide the dentist with substantially improved control over where cutting of dentin occurs and therefore causes much less unintended cutting of dentin and change of the natural curvature.

The substantially non-cutting pilot portion 10 may have a diameter small enough to allow an instrument 12 to enter the apical area of the root canal of a human tooth and to act as a guide to follow the canal to the apex. Thus, the purpose of the pilot portion 10 is to guide the instrument 12, and not necessarily to perform any cutting. In one embodiment, the pilot portion 10 may be a non-cutting portion. In some embodiments, the substantially non-cutting portion 10 may include an abrasive surface. The abrasive surface may be imparted through coating, sandblasting, anodizing, ion implantation, etching, electro-polishing or combinations thereof, as further discussed below. In still other embodiments, the pilot portion 10 may have raised edges or other projections on its surface, as long as they do not cause the pilot portion 10 to have a substantial cutting effect.

The pilot portion 10 may be, for example, between about 0.01 and 14 mm long, more for example between about 0.75 and 3 mm. The working portion 22 may be, for example, between about 0.5 and 14 mm long, more for example, between about 0.5 and 4.0 mm long.

The pilot portion 10 and working portion 22 may both be tapered or nontapered. If tapering is used in the pilot portion 10, it may usually increase in diameter from its proximal end to its distal end.

The shank 16 may generally have a constant diameter, but may also be tapered, as noted before.

In FIG. 3, the pilot portion 10 is a short portion extending from the end 20 of the working portion 22. As shown, the pilot portion 10 is a smooth tapered cylinder with a blunt proximal end. In other embodiments, the pilot portion 10 may have rounded (bullet shaped) ends, as exemplified in FIG. 3a, where it is present as a slight extension or a stump at the end 20 of the working portion 22. This may be rounded, and may be generated by grounding or polishing the working end 20.

In FIG. 3b, the pilot portion 10 is almost of the same length as that of the working portion 22. In this configuration, the instrument 12 may be useful a coronal shaper. In FIGS. 3 and 3b, the pilot portion 10 as shown is also a smooth cylinder having a uniform circumferential span, for example, diameter, along its length, except for the end. In other embodiments, the pilot portion 10 may be tapered towards the end. As shown, the end of FIGS. 3 and 3b are not rounded. In other embodiments, the end may be rounded, such as shown in FIG. 3a, as noted before.

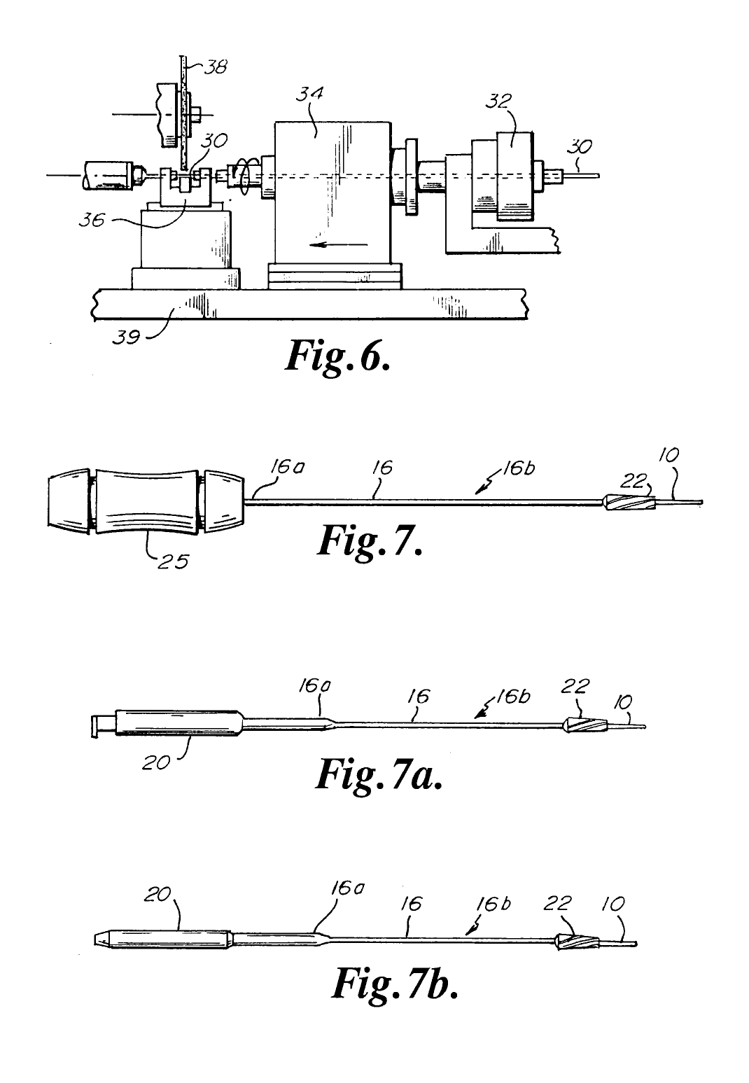

One embodiment of an exemplary process for making an instrument 12, is shown schematically in FIG. 5, In FIG. 5, a blank 30 having a diameter corresponding to the maximum diameter of the working portion 22 may be fed through a grinding apparatus, such as that exemplified in FIG. 6, to be described below. Some details of this apparatus may also be found in U.S. Pat. No. 5,464,362, the content of which is incorporated herein by reference.

The exemplary process includes:

providing a blank 30 having a length and a circumferential span in process 1;

grinding the blank 30 to form a non-working shank 16 having a proximal end 16a and a distal end 16b, at least a portion towards the proximal end 16a having substantially the same circumferential span as that of the blank 30, and at least a portion towards the distal end 16b having a substantially smaller circumferential span than that of the blank 30 in process 2;

forming a working portion 22 having at least one working surface 18, said working portion extending not more than the length of the non-working shank 16 on said blank 30, and having a maximum circumferential span substantially corresponding to the circumferential span of the blank 30 in process 3; and

forming a pilot portion 10 near one end of the instrument 12 close to the working portion 22 in process 4.

In another embodiment, the processes may be performed in any order. These processes may be carried out using an apparatus as exemplified in FIG. 6, described below.

The process may include treating at least a portion of the instrument 12 including at least a portion of the shank 16, the working portion 22, the pilot portion 10 or combinations thereof. The treatment process may be carried out prior to or after the grinding the grinding process, as shown in dotted line in FIG. 5. The treatment process may also be repeated.

As noted above, FIG. 6 schematically illustrates an exemplary machining apparatus for practicing the method of the present invention. The grinding process itself may be any known process, such as that described in U.S. Pat. No. 5,464,362, also noted above.

An instrument 12 may be made from a blank 30 having, for example, a diameter that is substantially equal to the largest diameter of the working portion 22. Blanks 30 with other cross-sectional configuration may be used, as discussed above. In accordance with an illustrated embodiment of the present invention, the blank 30 may be in a continuous spool, as noted above, and may be positioned to extend through an axial feed block 32 and an indexing block 34 as shown in FIG. 6. A holding fixture 36 is positioned to support the forward end of the blank 30 adjacent the periphery of a rotating grinding wheel 38.

In the embodiment as shown in FIG. 6, the blocks 32, 34 may be advanced so that the blank 30 may move axially past the rotating grinding wheel 36 at a speed of, for example, between about 3 to 8 inches per minute (75 mm to about 200 mm), and more for example, of not more than about 5 inches (about 125 mm) per minute, if a blank of nickel-titanium is used. In other embodiments, higher rotation rates may be used. Concurrently with this axial movement, the indexing block 34 may also slowly rotate the blank about its axis at a controlled speed, so that the ground surface of the working portion 16 may have a helical configuration as described above with respect to FIGS. 2 and 2a, if desired. In other embodiments, the indexing block may be stationary, or it may have a slight translational movement for generating working surfaces having other configurations, such as those as shown in FIGS. 3, 3a, 3b, 4, 4a, 4b, 4c, 4d, 4e and 4f.

The blank 30 may move past the wheel once or more than once for each ground surface, and thus the blank 30 may be positioned with respect to the wheel 38 such that the full depth of the cut is removed in a single pass or multiple passes, respectively.

The grinding wheel 38 may be rotated at a relatively slow surface speed of, for example, not more than about 3000 feet per minute, and more for example, not more than about 2200 feet per minute. Further, the wheel 38 may be composed of a relatively fine grit, which is greater than, for example, about 200 grits, and more for example, about 220 grits. The wheel 38 having the above grit sizes may be fabricated from silicon carbide. In other embodiments, diamond particles may also be used as the grinding surfaces.

The grinding wheel 38 may also be rotated at higher surface speeds. At the higher speeds, more than one pass may be employed.

The wheel 38 may be oriented to rotate about an axis generally parallel to the axis of the advancing blank 30 to form a working surface 18, for example, as shown in FIGS. 2 and 2a. For a slow rotating speed, a helical configuration may be achieved. If a tapered working portion 22 is desired, the axis of the index block 34 may be slightly inclined with respect to the rotational axis of the wheel 38, so as to provide a controlled and variable depth of cut along the working portion 22.

When the blank 30 has advanced past the rotating wheel 38 a distance sufficient to form the first working surface along the desired working portion 22 on the instrument 12, the table 39 supporting the feed block 32, the index block 34, and the fixture 36 may be moved laterally, then axially rearwardly, and then laterally back to its original position, while the blank 30 is concurrently rotatably indexed about its axis. The angular extent of this indexing will depend upon the number of working surfaces 18 desired on the finished instrument. For example, if three working surfaces 18 are to be formed on the working portion 22, the blank 30 may be indexed 120°. After forming the first working surface 18, the blank 30 may then again be axially advanced while being slowly rotated, and so as to form a second surface, and so on, if desired. The table 39 is then again moved laterally and rearwardly in the manner described above, and the blank 30 is rotatably indexed another 120°. The grinding process is repeated to form the third surface of the instrument 12.

If an instrument 12 has two working surfaces 18, the blank 30 is indexed 180° between the two machining operations.

After forming the working surfaces, the blank 30 may be ground to a smaller diameter to form a non-working shank 16 but leaving the blank 30 in its original diameter towards the proximal portion 16a prior to being severed by such methods, for example, by axially advancing the blank 30 and then moving the grinding wheel 38 laterally through the blank 30. For example, only the distal portion 16b may be ground so that the proximal portion is of approximately the same diameter as the largest diameter working portion 22, such as exemplified in FIG. 8b. In another embodiment, the shank 16 may be ground in such a way that the distal end 16b transitions smoothly from the distal end 24 of the working portion 22 and tapers towards the proximal end 16a, as shown in FIG. 9. In yet a further embodiment, the shank 16 may be ground to have a portion 16c having a reduced circumferential span or diameter, as shown in FIG. 9a. The grinding may be taken in any order other than as illustrated above, if other configurations of the working surfaces are desired.

The severed blank/instrument 12 may then be further treated. The treatment process may include coating, sandblasting, anodizing, ion implantation, etching, electro-polishing, heat setting, cryogenic treatment, or combinations thereof. The treatments including coating, sandblasting, anodizing, ion implantation, electro-polishing, etching or combinations thereof, may be performed to modify the surfaces of at least a portion of the working portion 22, and/or the shank 16, and/or the pilot portion 10. The treatment may also act to remove any burrs that may form during the grinding process.

In addition, the surface treatments may also remove any oxidized material, for example, an oxide layer that may be present on the surface of the blank 30 that is generated during the manufacturing process of the blank 30. The oxidized layer may be regenerated even after the treatment, but not to the same extent as the untreated surfaces. The removal of the oxidized layer may also improve the cutting efficiency of the working portion 22.

In another embodiment, after the treatment, or as the treatment process, a coating may be formed on the surface. This coating may, on the one hand, minimize the re-forming of the oxidized layer, while at the same time provide friction reduction and/or durability enhancement, as discussed further below.

In a further embodiment, the existence of the oxide layer may be advantageous in improving corrosion resistance, durability and/or finishing of the surface. An oxide layer of titanium may, for example, impart coloring to the surface based on the thickness of the layer and may be utilized as a wear or depth indicator. Oxide layers thicker than an untreated passivation layer may also impart increased corrosion resistance and durability as many metal oxides are extremely hard and thicker layers may be less prone to wearing that may expose the metal surface and lead to corrosion. Increasing the thickness of the oxide layer may also be useful in preserving the layer when exposed to environments where oxygen is not available to regenerate the layer.

If a flattened working portion 22 is desired, as shown in FIGS. 4d, 4e and 4f, a flattened blank 30 may be used to generate an entire flattened instrument 12. The feed block 32, the index block 34 and the fixture 36 may be modified and adapted for such a blank 30. In another embodiment, a non-flattened blank 30 may be used, an additional compression process may be implemented to form the flattened working portion 22. In yet another embodiment, a non-flattened blank 30 may be used and the flattened working portion 22 may be formed by grinding.

In one embodiment, the flattened working portion may vary in thickness, from a thinner edge to a thicker central portion. In another embodiment, the thickness of the working portion may be substantially uniform.

The instrument 12 may also undergo cryogenic treatment, heat setting, combinations thereof, or others, provided that any or combinations of these treatments do not adversely affect the surface properties imparted by the surface treatments, if any of these treatments is previously performed on the instrument.

In another embodiment, the process of fabricating an instrument using a treated blank is disclosed, as is also shown in FIG. 5, in dotted lines.

The treatment may include coating, sandblasting, anodizing, ion implantation, electro-polishing, etching, or combinations thereof, as disclosed above. Any or combinations of these treatments may serve to modify the surface properties of the instruments, as disclosed above. Other treatments, including cryogenic treatment, heat setting or combinations thereof, may serve to improve the bulk properties, for example, the strength of the metal, polymer or alloy, by, for example, modifying the molecular structure of the base material. These may also be used in combination with the surface treatments mentioned above, either before or after any of the other treatments, provided that one type of treatment does not adversely change or affect the desirable effects imparted by another type of treatment, as noted. In general, the properties least likely to be affected by other treatment methods are performed first.

A suitable cryogenic treatment is described in U.S. Pat. No. 6,314,743, the content of which is incorporated herein by reference. An exemplary treatment may involve a cryogenic cycle having a cool down phase from an initial start time, during which the blank 30 may be cooled down in a dry cryogenic environment to about −300° F., over a span of between about six (6) and eight (8) hours, followed by a cryogenic hold phase during which the blank 30 may be held at about −300° F. over between about twenty-four (24) and thirty-six (36) hours, followed by a cryogenic ramp up phase during which the blanks 30 are ramped up to about −100° F. over between about six (6) and eight (8) hours. Then a first tempering cycle having a ramp up phase may be performed, during which stage the blank is ramped up in a dry tempering environment to about 350° F. over about one-half (½) hour, followed by a hold phase during which the blank 30 may be held at about 350° F. over about two (2) hours, followed by a ramp down phase to below about 120° F., but not generally all the way to the ambient temperature, over between about two (2) and three-and-half (3½) hours. A second tempering cycle may follow which may have a time-temperature profile fairly comparable to the first tempering cycle. In some methods, a third tempering cycle may be performed.

The cryogenic ramp down phase may be arranged to have a varying rate of descent. For example, the descent may be steeper initially from ambient to about −100° F. and then more gradual thereafter for temperatures below −100° F. to about the cryogenic hold temperature of about −300° F. The temperature descent from the start time at ambient temperature to the about −100° F. level may be achieved over about the first one (1) hour after the start time, while the temperature descent from below about −100° F. to about −300° F. may be achieved over between about five (5) and seven (7) hours.

The cryogenic ramp up phase may also have a varying rate of ascent, for example, that may correspond to an exponential decay of the cryogenic hold temperature from the about −300° F. to about −100° F. over between the about six (6) and eight (8) hours. The exponential decay of the cryogenic hold temperature from the about −300° F. to about −100° F. may also include a stage when a temperature of about −200° F. is not reached from the base hold temperature of −300° F. until six (6) hours into the cryogenic ramp up phase, while the remaining decay up to −100° F. occurs over a next two (2) hours. In other embodiments, the exponential decay of the cryogenic hold temperature from the about −300° F. to about −100° F. may be arranged to transpire such that a temperature of about −200° F. is not reached from the base hold temperature of −300° F. until five-and-a-half (5½) hours into the cryogenic ramp up phase, the remaining decay up to −100° F. occurring over a half (½) hour period.

In an exemplary embodiment, the cryogenic environment may be provided by a Dewar chamber and the tempering environment may be provided by a convection oven. Accordingly, the transition between the cryogenic cycle and the first tempering cycle would entail physical transfer of the blank from Dewar chamber to the convection oven.

Typically, a hold down phase at about −300° F. may extend between about twenty-four (24) and thirty-six (36) hours. During this “hold phase” the blank 30 may thermally contract. If the blank 30 is made of metal or a metallic alloy, it is surmised that the microstructure re-organizes itself to become more spatially uniform. This uniformity may provide stronger blanks for making the instruments by decreasing the packing density defects.

Another cryogenic process is disclosed in U.S. Pat. No. 6,332,325, incorporated herein by reference. The process subjects an article of manufacture to extreme negative temperatures and cycling the article between a set of negative temperatures for a number of cycles. The process is completed by heating the article to an extreme positive temperature and then allowed to cool to ambient room temperature. It is shown that this cryogenic thermal cycling process strengthens the article by realigning its molecular structure to eliminate micro-cracking and other manufacturing deforming characteristics.

Other cryogenic treatment methods may be found, for example, U.S. Pat. No. 4,482,005 (Voorhees), or U.S. Pat. No. 5,259,200 (Nu-Bit, Inc.), the content of which is incorporated herein by reference. The Voorhees patent discloses a cryogenic cycle having ramp down and ramp up phases flanking a wet or immersion “soaking” phase. The Voorhees discloses that for “tool steel”, the wet process produces an instrument with longer lasting sharpness. The Nu-Bit patent discloses a quenching process by essentially dropping a target into a liquid nitrogen bath, and let set there for the ten (10) minutes or soon, sufficient time for the liquid nitrogen to boil away. After the bath, the instrument is brought back to room temperature by a jet stream of room-temperature air, making the entire process a forty minute start to finish (including the 10 minute bath) process. This quick dip method reports a gain of up to a fifty fold (50×) improvement in drill bits. Both of these methods may have to be modified to be practiced for blanks 30 used to make fine instruments 12 like endodontic files.

The cryogenic treatment may be amenable to blanks 30 after they have been manufactured, for example, after they have been drawn into the form of blanks 30, other treatment process may also be amenable to be performed during, for example, the extrusion or drawing process. For example, heat treatments or varying drawing speeds may be used to modify the properties of the blanks 30, for example, to strengthen the blanks 30, during their manufacturing process. For heat setting treatments, a cycling between hot and cold may be employed. The rate of the heating and cooling cycles may also be varied. Other thermal treatments may include localized laser treatment. By varying the aging temperature, the drawing or extrusion rates, the rate of heating and cooling cycles, any irregularities in the molecular structure or molecular packing may be modified. Multiple incremental drawing or deformation may also result in better uniformity and better properties than single drawing process.

Some examples of these processes may be found in U.S. Pat. Nos. 4,704,329, and 6,332,325, the contents of which are incorporated herein by reference.

While some of these treatment methods may be more amenable to blanks 30 than instruments 12, they may be used for instruments 12 also, with some modifications. For example, the method discussed in U.S. Pat. No. 6,332,325 may be used to strengthen the blank 30 by realigning its molecular structure to eliminate micro-cracking and other manufacturing deforming characteristics, as noted above. Therefore, though some of these processes have been described with respect to the blank 30, the instruments 12 may be described in similar manners.

Coating, sandblasting, etching, anodizing, ion implantation or electro-polishing, as noted above, may be used to modify the surface properties of the instruments 12 or blanks 30. For example, a micro-abrasive sandblasting device disclosed in U.S. Pat. No. 6,347,984 may be a suitable device for treating endodontic instruments 12 of the present invention, the content of which is incorporated herein by reference. Another suitable device may be one disclosed in U.S. Pat. No. 5,941,702, the content of which is also incorporated herein by reference. This exemplary device disclosed is a dental air-abrading tool typically used for etching hard surfaces to enhance bond strength of adhesives, which includes a solid body having internally reamed passageways through which a gaseous fluid and an abrasive material are carried. A connector is mounted on one end of the body for connecting one of the body's internal passageways to a supply of gaseous fluid and a nozzle is mounted on the other end of the body for directing the gaseous fluid to a surface. A supply of an abrasive material is coupled to another internal passageway of the body. The nozzle includes an internal mixing chamber for mixing the gaseous fluid and abrasive material entering therein from the body's internal passageways. Some slight modifications may be made to adapt it for use in the present invention

Other physical alterations of the surface such as burnishing, may also result in a surface layer with reduced excess oxides.

Other exemplary treatment methods may be found in U.S. Pat. Nos. 6,605,539, 6,314,743, 5,775,910, and 5,393,362, the contents of all of which are hereby incorporated by reference.

Chemical etching may also be used and may be carried out in any known process, including nitric acid passivation.

Ion implantation is another method that may be used, to impart changes to either small or large regions of the surface of the blank 30, for example, to generate an amorphous surface, which may lead to increased surface hardness, reduced surface friction coefficient, increased wear resistance, reduced surface wetting behavior, and even an enhancement in passivation, if desired. Ions useful for implantation may include oxygen, nitrogen, carbon, boron, cobalt. Process conditions during ion implantation may also be controlled to minimize hydrogen embrittlement.

These surface treatment processes may be performed either on the blank 30 or the instrument 12, as noted above. When performed on the blank 30, the modification may be present on portions of the instrument 12 that have not been ground, for example, the proximal portion 16a of the non-working shank 16, if desired, and/or portions of the peripheral surfaces and/or cutting edges 18 of the working portion 22.

Surface modification such as roughening made by sandblasting, or chemical modification made by chemical etching, anodizing or ion implantation, on the proximal end 16a of the non-working shank 16 may aid in the attachment of the shank 16 to a handle 25, as shown in FIGS. 7, 7a and 7b. The handle 25 may be attached by crimping, by an adhesive, or combinations thereof.

Such surface modification on the proximal end of the non-working shank 16 either macroscopically or microscopically, depending on the treatment, may result in the increase of the attachment strength of the shank 16 to the handle 25, decreasing the chances of separation between the handle 25 and the instrument 12 during operation, as discussed further. When the modification is performed on the instrument 12 after the instrument 12 has been formed, the coating, sandblasting, anodizing, ion implantation, etching or electro-polishing process may be performed on the entire instrument 12 or on selected portions of the instruments 12, to modify the entire instrument 12 or only the desired portion or portions. The process may also remove any burrs or irregularities generated during the manufacturing process while creating a modified surface structure at the same time.

Coating, sandblasting, anodizing, ion implantation, etching or electro-polishing may also modify the working surfaces 18, whether performed on the blank 30 or the instrument 12. When performed on the blank 30, the treated areas may be the working surfaces 18 that are part of the original blank 30, i.e., the working surfaces 18 having the same circumferential span or diameter as the starting blank 30. Additional treatment may also be performed on portions of the instrument 12 after grinding, if desired. In other words, the treatment processes may be repeated.

Some treatment methods may also impart a different color to the treated portions. These colored portions may serve as length, depth or wear indicator, as discussed further below.

In addition, other chemical surface treatments for the blank 30 may be employed including coatings for friction reduction and/or durability. Some of these coating may include titanium nitride coating, tungsten carbide coatings, diamond-like carbon coatings, chromium coating, calcium immersion, and others for maintaining and improving the sharpness of the working surfaces 18 and to minimize the built up of oxide layers, as noted above. The formation of titanium nitride on a passivated surface was reported to enhance the barrier to further Ni2+ ion migration, as noted in an article by L. Tan, W. C. Crone/Acta Materialia 50 (2002) 4449-4460, the content of which is hereby incorporated by reference.

In one embodiment, for a coated or treated blank 30, the coating or treated surface may be of a color different form the blank 30 itself. This color may remain on the un-ground portion. For the working portion 22, the un-ground portion may serve as a depth or length indicator.

During a grinding process, a fixed grinding and turning speed may result in, for example, helical cutting edges 18 being formed at regular intervals along the working portion 22. As the edges 18 may be of the same circumferential span as the blank 30, these edges may not have undergone any grinding. The un-ground edges 18 would thus have a different color as the ground portions. When the edges 18 appear at regular intervals, such colored intervals may be useful in indicating the length or depth of the file inside a canal during use. For example, the first cutting edge 18 following the pilot portion 10 may be indicated as 1, with a corresponding correlation table for indicating the distance from the tip of the pilot portion 10, either to the beginning and/or the end of the edge 18, as the edge 18 is slanted. Such colored blanks 30 may also serve to indicate the wear characteristics of the instrument.

Similarly, when the coating or treatment is carried out on the cutting surfaces 18 of the instrument 12, the color may likewise serve as a length, depth or wear indicator.

Further, a treatment process having a sequence of first reducing the oxide layer prior to drawing, then add treatments such as electro-polishing, anodizing, coatings including various coatings mentioned before, and drawing again, may be used either on the blank 30 or on the instrument 12.

The present invention also relates to the manufacture of a set of endodontic instruments 12 having varying maximum circumferential spans, for example, diameters. In one embodiment, one blank 30 having a circumferential span is made into one instrument 12 in the set and the circumferential span of the blank 30 corresponds to the maximum circumferential span of the working portion 22, and/or the proximal end of the instrument 12, such as shown in FIGS. 8a-8c. Each of the instrument 12 shown in FIG. 8a includes forming a working portion 22 including at least one working surface 18 having a circumferential span, said working portion 22 extending not more than the length of the non-working shank 16 and having a maximum circumferential span substantially corresponding to the circumferential span of the respectively blank 30. In the exemplary embodiment as shown in FIG. 8a, the working portion 22 has a substantially circular cross-section, and at least two spiral or helical working surfaces 18, as is also shown in FIG. 2. In other embodiments, working surfaces 18 may have configurations like those exemplified in FIGS. 2a, 3, 3a, 3b, 4, 4a, 4b, 4c, 4d, 4e and 4f, discussed above.

The number of instruments 12 in a set may vary, for example, from as few as three instruments 12 in the set, though typically more than three in a set, and more typically more than 6 in a set, all having different circumferential spans. In general, the dental professional starts with the one having the smallest circumferential span and progressively moves to larger and larger ones, until the root canal is fully cleaned and prepared for filling.

As shown in FIG. 8a, each of the non-working shank 16 is ground to have a diameter that is substantially smaller than the diameter of the blank 30, each shank portion 16 having a different diameter from the others in the series.

In another embodiment, a set of instruments 12 are made from a set of blanks 30 having an identical circumferential span. Each blank 30 may be ground to generate a non-working shank 16 having a proximal end 16a, a distal end 16b, and at least a portion having a substantially smaller circumferential span than that of the blank 30. In one embodiment, only one instrument in the set may have a working portion 22 having a maximum circumferential span substantially corresponds to the circumferential span of the blank 30 and a portion of the shank portion 16 of each of the instruments 12 in the set may be of substantially the same circumferential span, which is smaller than the circumferential span of the blank 30. In another embodiment, only one instrument 12 in the set may have at least a portion of the shank portion 16 that is of the substantially the same circumferential span as that of the blank 30, and all the other ones have smaller circumferential span than the blank 30.

The pilot portion 10 is formed near one end close to the working portion 22 of each instrument 12, as described above. The proximal end 16 of the non-working shank 16 may be adapted to be attached to a handle 25, is shown in FIGS. 7, 7a and 7b. The distal end 16b is adjacent to the working portion 22, which may have a configuration similar to those discussed in FIGS. 2, 2a, 3, 3a, 3b, 4, 4a, 4b, 4c, 4d, 4e and 4f. The pilot portion 10 and the non-working shank 16 may also have any of the configurations disclosed previously.

Only three instruments 12 are shown here in the example. In practice, as many instruments 12 having a working portion with different maximum circumferential span or diameter as is desired by a practitioner may be manufactured.

These instruments 12 may also undergo treatment using any of the treatment methods disclosed above, including coating, sandblasting, anodizing, ion implantation, electro-polishing, etching, heat setting, cryogenic treatment, or combinations thereof, for modifying the working portion 22, and/or the shank 16, and/or the pilot portion 10. In another aspect, the set of blanks 30 used may be subjected to the same treatments or combinations thereof.

The blanks 30 may also be treated prior to the grinding process, as noted above. In one aspect, the blank 30 may be treated at its manufacturing stage. In another aspect, the blank 30 may be treated after the manufacturing process, but before the grinding process.

According to another embodiment of the invention, the method for manufacturing a set of endodontic instruments 12 may include providing a set of groups of blanks 30, each group having at least two blanks 30, and the number of groups are of a smaller number than the number of instruments 12 in the set, wherein each blank 30 includes a circumferential span, and each group having a different circumferential span from another group.

The working portion 22 including a working surface 18 and a circumferential span, may extend no more than the length of the non-working shank 16. The configuration of the working surfaces 18, the pilot portion 10, and the non-working shank 16, may be as shown in FIG. 2, or may be similar to those shown in FIGS. 2a, 3, 3a, 3b, 4, 4a, 4b, 4c, 4d, 4e and 4f, discussed above.

Although more than one instrument 12 may be made from blanks having the same circumferential span, for example, diameter, only one instrument 12 in a set made from each group of blanks 30 may have a working surface having a maximum circumferential span substantially corresponding to the circumferential span of each group of blanks 30, such as exemplified in FIG. 8b. FIG. 8b shows a series of three instruments 12 in a set made from blanks 30 having the same circumferential span or diameter. In one embodiment, at least one of the instruments 12 in a set made from the same group of blanks 30 may have at least a portion towards the proximal end 16a of the shank portion 16 having substantially the same circumferential span as that of the blank 30, as exemplified here in FIG. 8b. In other embodiments, the entire length of the shank 16 may be ground to be of one uniform circumferential span, the same in all three instruments 12, as shown in FIG. 8c. This process has the advantage of stocking fewer sizes of starting blanks 30 than the above process of making each instrument 12 having a different maximum circumferential span out of a respective blank 30 having a circumferential span similar to the maximum circumferential span of the working portion 22, although the process described earlier has the advantage of not having to remove more material from the blank in order to make an instrument 12 having a smaller circumferential span than the circumferential span of the starting blank 30, saving material and process cost.

As mentioned before, in one embodiment, a series of two instruments 12 in a set may be made from one group of blanks 30 having identical circumferential span even though only one of the instruments 12 in the set may have a working portion 22 having the same circumferential span as the blank 30. In another embodiment, a series of three instruments 12 in a set may be made from a group of blanks 30 having an identical circumferential span even though only one of the instruments 12 in the set may have a working portion 22 having the same circumferential span as that of the blank 30. In other embodiments, more than three instruments 12 in a set may be made from a group of blanks 30 having identical circumferential span even though only one of the instruments 12 in the set may have a working portion 22 having the same circumferential span as that of the blank 30.

In one aspect, at least a portion of each of the instruments 12 including the shank 16, the working portion 22, the pilot portion 10 or combinations thereof may be treated, as noted above.

In another aspect, a set of blanks 30 having undergone coating, sandblasting, anodizing, ion implantation, etching, heat setting, cryogenic treatment, electro-polishing or combinations thereof may be used.

In one embodiment, the instrument 12 in each set may also have a handle 25 at its distal end for manual manipulation. In another embodiment, instrument 12 in each set may have a handle 25 at its distal end that is adapted for attachment to a mechanical handpiece. These are similar to those exemplified in FIGS. 7, 7a, 7b, except now in sets. A mechanical handpiece may be a rotary handpiece or a vibratory handpiece.

When adapted for rotation by means of a mechanical handpiece, the speed of rotation may be at any conventional level up to a level of about 400 to about 1,000 rpm. This is possible because of the short working portion 22 and smaller areas of contact between the working surfaces 18 and the canal walls. This is an improvement over the traditional instruments having a working portion along almost the entire length of the instrument.

Any of the surface treatments may also improve the strength of attachment between the handle 25 and the proximal end 16a of the instrument 12, as noted above. The surface treatment may tend to roughen the surfaces to increase the area of contact, either macroscopically or microscopically, depending on the treatment. This improvement also enables the instrument 12 to be rotated at the higher speeds with lower incidences of detachment between the instrument 12 and the handle 25.

When the attachment strength between the handle 25 and the instrument 12 is increased, any breakage, if any, may be more likely to occur at any weak points generated by the grinding process, rather than the separation between the handle 25 and the proximal end 16a of the instrument 12. To increase the likelihood that such breakage may occur towards the proximal end 16a of the shank portion 16, rather than at the transition between the working portion 22 and the distal end of the shank 16b, for the instruments 12 with a shank 16 having small circumferential span or diameter, the shank 16 may be tapered, such as exemplified in FIG. 9, so that the weak point may be more likely to be towards the thinner proximal end 16a of the shank 16, and any broken parts of the instrument 12, if lodged in the canal, may be more easily removed.

In another aspect, such as shown in FIG. 9, the proximal end 16a of the shank 16 has a smaller diameter than the distal end 16b and the transition between the distal end 16b of the shank 16 and that distal end 24 of the working portion 22 is gradual and smooth, reducing or minimizing any stress that may be created by the grinding process.

In a further aspect, if desired, the shank 16 may be ground to have a portion 16c having a reduced circumferential span or diameter, as shown in FIG. 9a. The reduced diameter portion 16c may take the shape of a groove (U-shaped) or a notch (V-shaped). This reduced diameter portion 16c provides a predictable break point, in case the instrument 12 encounters some blockage in the canal that may impede its progress so that the instrument 12 may break at the reduced diameter portion 16c for easier retrieval from the tooth. This reduces the chance of having a broken piece of an instrument lodged deep within the canal of the tooth. In addition to serving as a predetermined weakness point, the reduced diameter portion 16c may also be adjusted to serve as a depth of cut indicator.

Any surface treatments on the working portion 22 may also lead to better cutting efficiency. This may also lower the degree of discomfort for the patient.

As noted above, a blank can be a spool or can be a single piece.

The pilot portion 10 and/or the working portion 22 may be formed by grinding, as exemplified above, they may also be formed by molding or casting.

While particular embodiments of the present invention have been shown and described, it will be obvious to those skilled in the art that changes and modifications may be made without departing from the invention.

1-9. (canceled)

10. A method for manufacturing a set of an endodontic instruments comprising:
providing a set of blanks, said blanks having varying circumferential spans;
grinding each of said blank to form a non-working shank portion having a length, a proximal end, and a distal end, wherein at least a portion of said shank portion having a substantially smaller circumferential span than that of the blank;
forming a working portion on each blank adjacent to the distal end of said shank portion and extending not more than the length of the non-working shank, said working portion having a maximum circumferential span substantially corresponding to the circumferential span of the blank; and
forming a pilot portion near one end of the instrument close to the working portion.

11. The method of claim 10 wherein said pilot portion comprises a non-cutting portion, abrasive surfaces, or a continuous extension of the working portion.

12. The method of claim 10 further comprising treating at least a portion of each of the instruments comprising at least a portion of the shank, the working portion, the pilot portion or combinations thereof.

13. The method of claim 12 wherein said treating comprises coating, sandblasting, anodizing, ion implantation, electro-polishing, etching, heat setting, cryogenic treatment, or combinations thereof.

14. The method of claim 12 wherein said treating is performed prior to the grinding process, or during the manufacturing of the blank.

15. The method of claim 10 further comprises flattening at least a part of the working portion.

16-26. (canceled)
